(19) United States
(12) Patent Application Publication
(10) Pub. No.: US 2005/0267755 A1
(43) Pub. Date: Dec. 1, 2005

(54) Arrangement for speech recognition

(75) Inventor: Janne Suontausta, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/855,801

(22) Filed: May 27, 2004

(51) Int. Cl. G10L 15/00

(52) U.S. Cl. 704/254

(57) ABSTRACT

A speech recognizer comprises a random access memory, a downloader for loading decision trees from a set of decision trees into said random access memory, a vocabulary comprising one or more words of a language, a divider for dividing at least one word of the vocabulary into subwords, and a transcription generator adapted to process at least one subword. The downloader is adapted to download a subset of the set of decision trees at a time into said random access memory. The transcription generator is further adapted to generate at least one phoneme transcription for the subword using the subset of decision trees. The speech recognizer also comprises a combiner for combining the generated phoneme transcriptions of the subwords to obtain phoneme transcriptions of said one or more words. The invention also relates to a device, a system, a module, a method, a computer program product and a data structure.

### FIELD OF THE INVENTION

The invention relates to a method for producing phoneme transcriptions for speech recognition. The invention also relates to a speech recognition system. The invention relates to a speech recogniser, a module for a speech recogniser, an electronic device, a computer program product, and a data structure.

### BACKGROUND OF THE INVENTION

Multilingual aspects are becoming increasingly important in the Automatic Speech Recognition (ASR) systems. That kind of speech recognition systems usually comprise a speech recognition engine which may, for example, comprise units for automatic language identification, on-line pronunciation modeling (text-to-phoneme, TTP) and multilingual acoustic modeling. The operation of the speech recognition engine works on an assumption that the vocabulary items are given in textual form. At first, the language identification module identifies the language, based on the written representation of the vocabulary item. Once this has been determined, an appropriate on-line text-to-phoneme modeling scheme is applied to obtain the phoneme sequence associated with the vocabulary item. The phoneme is the smallest item that differentiates the pronunciation of a word from the pronunciation of another word. Any vocabulary item in any language can be presented as a set of phonemes that correspond the changes in the human speech production system.

In addition to speech recognition, the on-line pronunciation modeling unit can be utilized in text-to-speech (TTS) systems. Typically, the TTS systems need the phonetic transcription of the words to be synthesized as an input. In an example TTS system based on the Klatt TTS engine, first prosody parameters are found for the phoneme sequence with the prosody models. Given the phoneme sequence and the prosodic parameters, the synthesis parameters are updated with the phoneme to parameter (P2P) unit that applies certain TTS rules in order to smooth the transitions of the Klatt TTS parameters between the phonemes in the input sequence. Finally, the waveform is synthesized with the updated P2P parameters and the prosodic information.

In a speech recognition system, the multilingual acoustic models are concatenated to construct a recognition model for each vocabulary item. Using these basic models the recognizer can, in principle, automatically cope with multilingual vocabulary items without any assistance from the user. Text-to-phoneme has a key role for providing accurate phoneme sequences for the vocabulary items in both automatic speech recognition as well as in text-to-speech. Usually neural network or decision tree approaches are used as the text-to-phoneme mapping. In the solutions for language- and speaker-independent speech recognition, the decision tree based approach has provided the most accurate phoneme sequences. One example of a method for arranging a tree structure is presented in the patent U.S. Pat. No. 6,411,957.

In the decision tree approach, the pronunciation of each letter in the alphabet of the language is modeled separately and a separate decision tree is trained for each letter. When the pronunciation of a word is found, the word is processed one letter at a time, and the pronunciation of the current letter is found based on the decision tree text-to-phoneme model of the current letter.

An example of the decision tree is shown in FIG. 1. It is composed of nodes, which can be either internal nodes I or leaves L. A branch is a collection of nodes, which are linked together from a root R to the leaf L. The node can be either a parent node or a child node. The parent node is a node from which the tree can further be traversed, in other words; has a child node. A child node in the tree is a node that can be reached from a parent node. The internal node I can be both a parent and a child node but the leaf can only be a child node. Every node in the decision tree stores information. Stored information varies depending on the context of a decision tree.

The pronunciations of the letters of the word can be specified by the phonemes (pᵢ) in certain contexts. Context refers, for example, to the letters in the word to the right and to the left of the letter of interest. The type of context information can be specified by an attribute (aᵢ) (also called attribute type) which context is considered when climbing in the decision tree. Climbing can be implemented with the help of an attribute value, which defines the branch into which the searching algorithm should proceed given the context information of the given letter.

The tree structure is climbed starting from the root node R. At each node the attribute type (aᵢ) should be examined and the corresponding information should be taken from the context of the current letter. Based on the information the branch that matches the context information can be moved along to the next node in the tree. The tree is climbed until a leaf node L is found or there is no matching attribute value in the tree.

A simplified example of the decision tree based text-to-phoneme mapping is illustrated in FIG. 2. The decision tree in the figure is for the letter ‘a’ wherein the nodes represent the phonemes of the letter ‘a’. It should be noticed that the illustration is simplified and does not necessarily include all the phonemes of the letter ‘a’. In the root node there is information about the attribute type, which is the first letter on the right and denoted by r₁. For the two other internal nodes, the attribute types are the first letter on the left denoted by I₁ and the second letter on the right denoted by r₂. For the leaf nodes, no attribute types are assigned.

When searching the pronunciation for the word ‘Ada’, the phoneme sequence for the word can be generated with the decision tree presented in the example and a decision tree for the letter ‘d’. In the example, the tree for the letter ‘d’ is composed of the root node only, and the phoneme assigned to the root node is phoneme /d/.

When generating the phoneme sequence, the word is processed from left to right one letter at a time. The first letter is ‘a’, therefore the decision tree for the letter ‘a’ is considered first (see the FIG. 2). The attribute r₁ is attached to the root node. The next letter after ‘a’ is ‘d’, therefore we proceed to the branch after the root node that corresponds to the attribute value ‘d’. This node is an internal node to which attribute r₂ is attached. The second letter to the right is ‘a’, and we proceed to the corresponding branch, and further to the corresponding node which is a leaf. The phoneme corresponding to the leaf is /el/. Therefore the first phoneme in the sequence is /el/.

The next letter in the example word is ‘d’. The decision tree for the letter ‘d’ is, as mentioned, composed of the root node, where the most frequent phoneme is /d/. Hence the second phoneme in the sequence is /d/.

The last letter in the word is ‘a’, and the decision tree for the letter ‘a’ is considered once again (see FIG. 2). The attribute attached to the root node is r₁. For being a last letter in the word, the next letter to the right of letter ‘a’ is the grapheme epsilon ‘_’. The tree is climbed along the corresponding branch to the node that is a leaf. The phoneme attached to the leaf node is /V/, which is the last phoneme in the sequence.

Finally the complete phoneme sequence for the word ‘Ada’ is /el/ /d/ /V/. The phoneme sequence for any word can be generated in a similar fashion after the decision trees have been trained for all the letters in the alphabet.

The decision tree training is done on a pronunciation dictionary that contains words and their pronunciations. The strength of the decision tree lies in the ability to learn a compact mapping from a training lexicon by using information theoretic principles.

As said, the decision tree based implementations have provided the most accurate phoneme sequences, but the drawback is large memory consumption when using the decision tree solution as the text-to-phoneme mapping. Large memory consumption is due to numerous pointers used in the linked list decision tree approach. The amount of the memory increases especially with languages such as English or the like, where pronunciation irregularities occur frequently.

A multilingual automatic speech recognition engine (ML-ASR) comprises three key units: automatic language identification (LID), on-line pronunciation modelling (i.e. text-to-phoneme), and multilingual acoustic modelling modules. The vocabulary items are given in textual form. First, based on the written representation of the vocabulary entry, the LID module identifies the language. Once this has been determined, an appropriate text-to-phoneme modelling scheme is applied to obtain the phoneme sequence associated with the vocabulary entry. Finally, the recognition model for each vocabulary entry is constructed as a concatenation of multilingual acoustic models. Using these basic modules the recogniser can, in principle, automatically cope with multilingual vocabulary entries without any assistance from the user.

In some prior art decision tree based text-to-phoneme implementations, the recognition vocabulary is read into RAM memory, and the entries in the vocabulary are processed in consecutive blocks. A block contains a subset of the entries in the recognition vocabulary. When the language IDs of the entries are known, the text-to-phoneme is carried out for all the entries in the block. The pronunciations for the entries in the block are found language by language. During this decoding step, the data of the text-to-phoneme method of each language are loaded, the pronunciations of the vocabulary entries for the current language are generated. Finally, the data of the current text-to-phoneme method are cleared. In this kind of implementations, all the text-to-phoneme model data of the current language (i.e. the text-to-phoneme data of all the letters in the alphabet of the language) are kept in RAM memory when performing the text-to-phoneme processing.

The text-to-phoneme processing has a key role for providing accurate phoneme sequences for the vocabulary entries in both automatic speech recognition as well as in text-to-speech processing. Usually, neural network (NN) or decision tree (DT) approaches are used as the text-to-phoneme mapping. The decision tree method usually provides the most accurate phoneme sequences and for this reason they are regarded as one of the best solutions for text-to-phoneme processing in an automatic speech recognition/text-to-speech engine. The drawback of the decision tree based text-to-phoneme processing is large memory consumption especially for irregular languages like English. Even though there exists a low memory implementation of the decision tree based text-to-phoneme mappings, the system is not fully optimised with respect of the RAM footprint (RAM memory requirements) for storing the decision tree information.

In a prior art implementation of the decision tree based text-to-phoneme, the pronunciations for the recognition vocabulary is obtained by processing the entries in successive blocks. A block is a fixed number of successive entries from the recognition vocabulary. The pronunciations for the block of entries are found language by language. During the processing, the text-to-phoneme model data of the current language is loaded, the pronunciations for the current language are generated, and the text-to-phoneme model data of the current language is cleared. The execution of the current decision tree based text-to-phoneme implementation for a block of entries is described by the following pseudo code.

for ALL LANGUAGES

for ALL ENTRIES IN BLOCK

for ALL LANGUAGES IN ENTRY

if LANGUAGE == LANGUAGE IN ENTRY

Create the instances of the text-to-phoneme
models for the language
Do symbol conversions for the entry
Produce the phoneme transcription for the current
language in the entry

end if

end for

end for
if text-to-phoneme MODELS INITIALIZED FOR THE LANGUAGE

Clear the instances of the text-to-phoneme models for the
language

end if

end for

During the execution, the instances of the decision tree based text-to-phoneme model structures are created. An example of the text-to-phoneme model data structure is described below:

typedef struct {

TreeInfo_t TreeInfo;
DecTree_t *DecTree;
uint8 NumTrees;
uint16 *nameInd;
uint16 *phoneSeq;

} ttpDTData_t;

The first member of the data structure stores the alphabet, the phoneme definitions, and the phonetic classes for the decision tree based text-to-phoneme model of a single language. The second member of the data structure is the array of decision trees corresponding to the letters in the alphabet. The third member of the data structure is the number of decision trees in the array. The fourth and fifth members of the data structures are the temporary variables that are initialised and cleared during the decision tree based text-to-phoneme processing.

During the initialisation of the instance of the decision tree based text-to-phoneme model of the current language, the whole array of the decision tree models corresponding to the alphabet of the current language is initialised and memory is allocated for it.

Both from the viewpoint of the automatic speech recognition performance as well as the text-to-speech quality, the accuracy of the decision tree based text-to-phoneme mapping is an important issue. In the prior art decision tree based text-to-phoneme, the decision tree based text-to-phoneme is carried out with the full context information. In the full context information, the phoneme context and the phoneme classes are included. The phoneme context contains the pronunciations of the previous letters, and the phoneme classes present the predefined groupings of the phonemes.

### SUMMARY OF THE INVENTION

According to the present invention there is provided an arrangement for building the models for speech recognition. According to the present invention the decoding step of the decision tree based text-to-phoneme decoding is performed in such a way that during the generation of the pronunciations of the current language for the block of entries, the pronunciations for the entries are found subword by subword for the vocabulary and finally concatenated to get the complete pronunciations. With this approach, the usage of the RAM memory can be reduced since only a subset of the text-to-phoneme data of the current language are kept in memory. In an example implementation of the present invention, the maximum size of the data that are held in memory for a single language can be restricted to the maximum size of the data that models the pronunciation of a single subword. Compared to the memory usage of prior art implementations, the memory usage of the example implementation of the invention is only a fraction. The subwords can be, for example, letters, a group of letters (e.g. syllables), etc.

According to the first aspect of the present invention there is provided a speech recogniser comprising
a random access memory;
a downloader for loading decision trees from a set of decision trees into said random access memory;
a vocabulary comprising one or more words of a language;
a divider for dividing at least one word of said vocabulary into subwords;
a transcription generator adapted to process at least one subword, wherein the downloader is adapted to download a subset of the set of decision trees at a time into said random access memory, and the transcription generator is further adapted to generate at least one phoneme transcription for said subword using said subset of the decision trees; and
a combiner for combining the generated phoneme transcriptions of the subwords to obtain phoneme transcriptions of said one or more words.

According to the second aspect of the present invention there is provided a device comprising
a random access memory;
a downloader for loading decision trees from a set of decision trees into said random access memory;
a vocabulary comprising one or more words of a language;
a divider for dividing at least one word of said vocabulary into subwords;
a transcription generator adapted to process at least one subword, wherein the downloader is adapted to download one decision tree at a time into said random access memory, and the transcription generator is further adapted to generate at least one phoneme transcription for said subword using said subset of the decision trees; and
a combiner for combining the generated phoneme transcriptions of the subwords to obtain phoneme transcriptions of said one or more words.

According to the third aspect of the present invention there is provided a wireless communication device comprising
a random access memory;
a downloader for loading decision trees from a set of decision trees into said random access memory;
a vocabulary comprising one or more words of a language;
a divider for dividing at least one word of said vocabulary into subwords;
a transcription generator adapted to process at least one subword, wherein the downloader is adapted to download one decision tree at a time into said random access memory, and the transcription generator is further adapted to generate at least one phoneme transcription for said subword using said subset of the decision trees; and
a combiner for combining the generated phoneme transcriptions of the subwords to obtain phoneme transcriptions of said one or more words.

According to the fourth aspect of the present invention there is provided a system comprising
a server comprising a mass memory for storing a set of decision trees, and a transmitter for transmitting information from the server;
a device comprising
   a receiver for receiving information from the server;
   a random access memory;
   a downloader for loading decision trees from the set of decision trees from said server into said random access memory;
   a vocabulary comprising one or more words of a language;
   a divider for dividing at least one word of said vocabulary into subwords;
   a transcription generator adapted to process at least one subword, wherein the downloader is adapted to download one decision tree at a time into said random access memory, and the transcription generator is further adapted to generate at least one phoneme transcription for said subword using said subset of the decision trees; and
   a combiner for combining the generated phoneme transcriptions of the subwords to obtain phoneme transcriptions of said one or more words.

According to the fifth aspect of the present invention there is provided a module comprising
a downloader for loading decision trees into a random access memory;
a divider for dividing at least one word of said vocabulary into subwords;
a transcription generator adapted to process at least one subword, said vocabulary comprising one or more words of a language, wherein the downloader is adapted to download one decision tree at a time into said random access memory, and the transcription generator is further adapted to generate at least one phoneme transcription for said subword using said subset of the decision trees; and
a combiner for combining the generated phoneme transcriptions of the subwords to obtain phoneme transcriptions of said one or more words.

According to the sixth aspect of the present invention there is provided a method for generating the phoneme transcriptions of words of a vocabulary of a language comprising:
loading decision trees into a random access memory;
dividing at least one word of said vocabulary into subwords;
processing at least one subword, wherein the processing comprising downloading one decision tree at a time into said random access memory, and generating at least one phoneme transcription for said subword using said subset of the decision trees; and
combining the generated phoneme transcriptions of the subwords to obtain phoneme transcriptions of said one or more words.

According to the seventh aspect of the present invention there is provided a computer program product for generating the phoneme transcriptions of words of a vocabulary of a language comprising machine executable steps for:
loading decision trees into a random access memory;
processing at least one subword, wherein the processing comprising downloading one decision tree at a time into said random access memory, and generating at least one phoneme transcription for said subword using said subset of the decision trees; and
combining the generated phoneme transcriptions of the subwords to obtain phoneme transcriptions of said one or more words.

According to the eighth aspect of the present invention there is provided a data structure including words of at least one vocabulary of at least one language for processing subwords of the words of the vocabulary, the data structure comprising:
subword and phoneme definitions;
decision trees for single subwords arranged for random access of the decision trees;
the data of the decision trees comprising information for obtaining phoneme transcriptions from subwords.

According to the ninth aspect of the present invention there is provided a computer program product for producing a data structure including words of at least one vocabulary of at least one language for processing subwords of the words of the vocabulary, the computer program product comprising machine executable steps for:
obtaining subword and phoneme definitions;
forming decision trees for single subwords on the basis of the phoneme definitions; and
arranging said decision trees for single subwords for random access.

One benefit of the invention implementing the decision tree based text-to-phoneme decoding is that the text-to-phoneme decoding can be run in less RAM memory compared to prior art systems. This is why the cost of the device running the decision tree based text-to-phoneme code can be made lower.

### DESCRIPTION OF THE DRAWINGS

In the following, the present invention will be described in more detail with reference to the accompanying drawings, in which

FIG. 1 shows an exemplary decision tree with nodes and leaves with attributes and phoneme,

FIG. 2 shows an exemplary decision tree for the letter ‘a’ used in a text-to-phoneme mapping,

FIG. 3 depicts the main elements of an example embodiment of the invention as a simplified block diagram,

FIG. 4a shows an example of a device in which the invention can be implemented,

FIG. 4b shows an example of another device in which the invention can be implemented,

FIG. 5 depicts a flow diagram of an example method according to the present invention, and

FIG. 6 shows an example of a system in which the invention can be implemented.

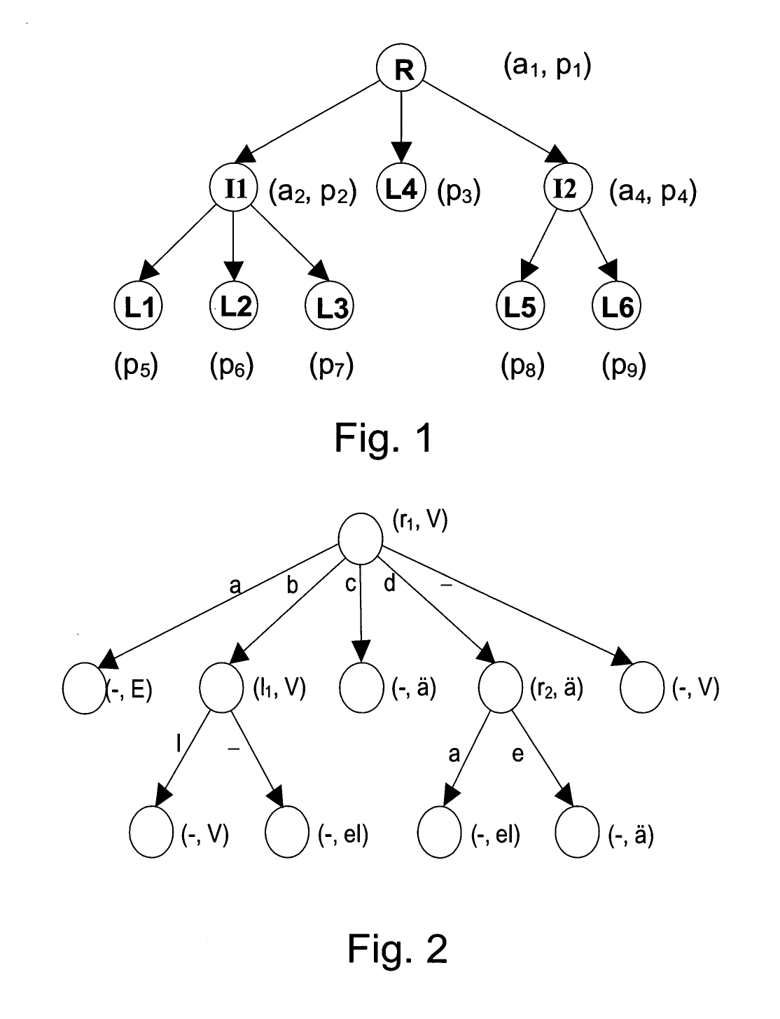

### DETAILED DESCRIPTION OF THE INVENTION

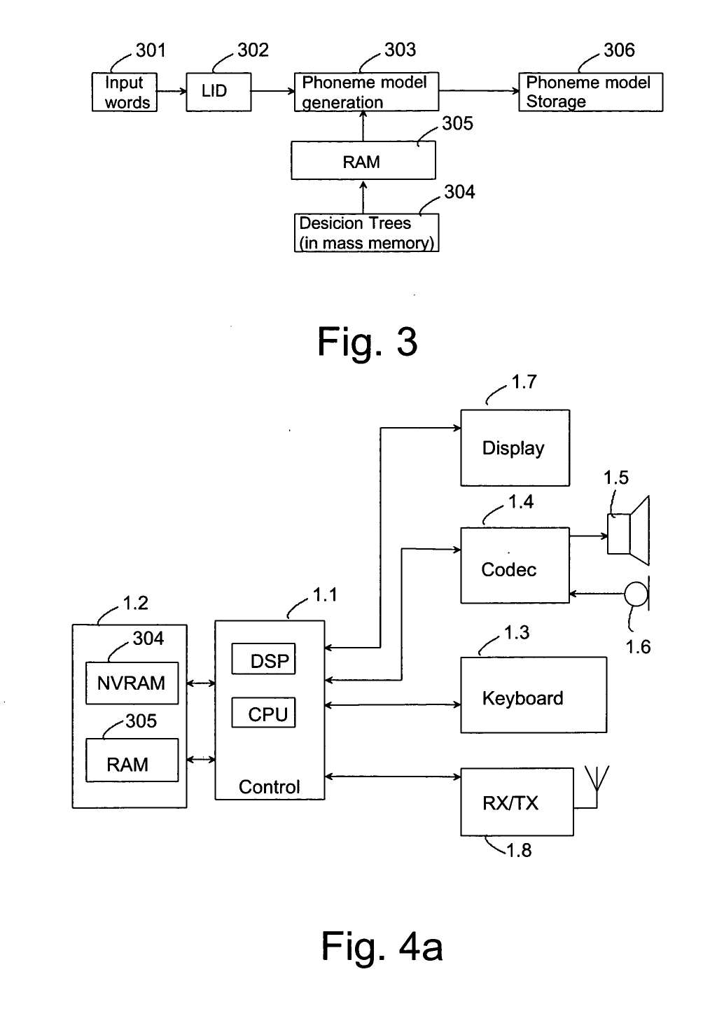

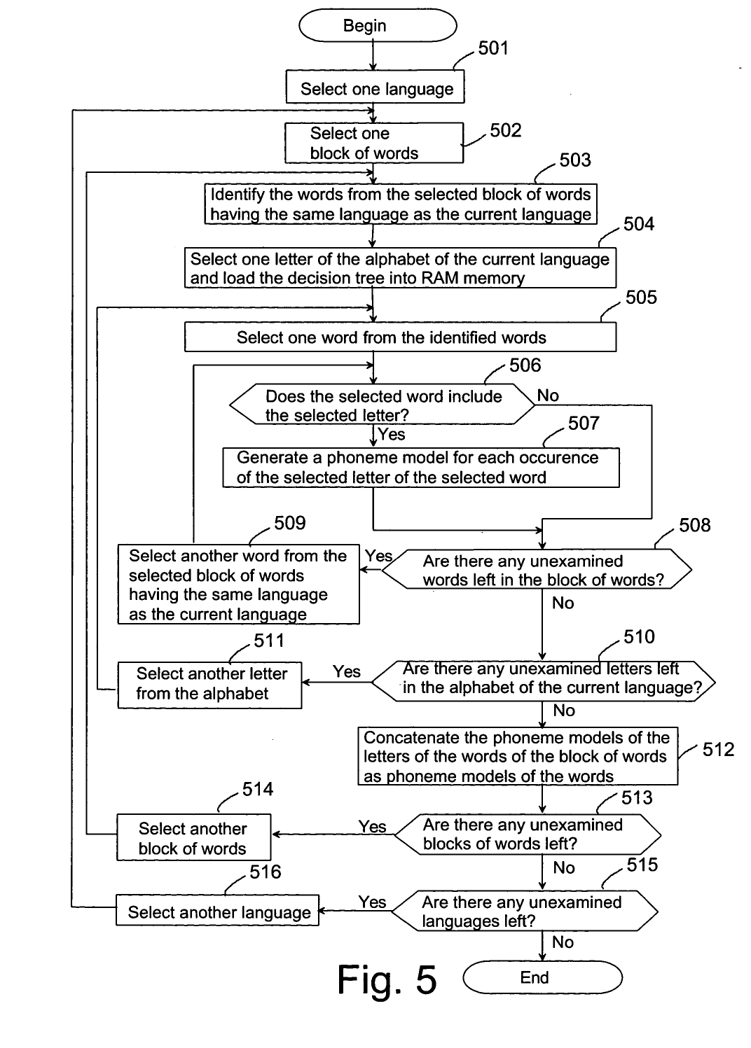

In the following a method according to an example embodiment of the present invention will be described in more detail with reference to FIGS. 3 and 5. FIG. 3 depicts the main elements of an example embodiment of the invention as a simplified block diagram and FIG. 5 depicts the flow diagram of the example method. It is first assumed that a certain vocabulary is defined or selected for the device in which the speech recognition will be used and that there may be more than one language in use. However, the invention can also be implemented in such a way that a vocabulary or vocabularies of only one language are used, wherein the language identification is not needed. It is also possible that the vocabulary is not fixed but may vary in different situations. For example, the user of a device may want to add new words to the vocabulary/vocabularies at some stage.

The phoneme generating unit 300 as depicted in FIG. 3 comprises the following elements in this example embodiment of the present invention. The words of the vocabulary are input 301 from, for example, an application software, from a database of a manufacturer of the device, etc. The language identifier 302 identifies the language of each word by some method. If only one language is used the language identification may not needed for each word. The language identifier 302 may also determine whether the word is a real word of a certain language or not. Hence, such words which are not determined to any of the languages in use can be ignored and no phoneme generation is not performed for such words in this example embodiment. The phoneme transcription generation element 303 performs the phoneme transcription generation for the words of the vocabulary according to the present invention. The phoneme transcription generator 303 uses the decision trees for the subwords of a language. The decision trees are stored into a mass memory 304 (non-volatile memory) such as a hard disk, a flash memory, etc. The mass memory 304 need not be arranged in the same device in which the phoneme transcriptions are generated but the mass memory 304 may be, for example, a mass memory of a server wherein a communication connection may be needed between the mass memory and the phoneme generating device 300. The decision trees can be loaded from the mass memory 304 to a RAM memory 305 of the phoneme generating device 300 on a subword-by-subword basis. This means that all decision trees are not loaded from the mass memory 304 to the RAM memory at once. In the example embodiment of the present invention only one decision tree is loaded to the RAM memory 305 at a time. However, the invention can also be implemented so that more than one decision tree but not all of them are loaded to the RAM memory 305 at a time. When all the subwords of the language are processed, the phonemes of the subwords of each word are concatenated as the phoneme transcriptions of the words (word models) and stored into the phoneme transcription storage 306. The words of the vocabulary may be processed in more than one block if the vocabulary is so large that there is not enough memory for processing the vocabulary as a whole. The subwords can be, for example, letters and/or syllables.

In FIG. 5 the flow diagram of a method according to an example embodiment of the invention is depicted. First, a language is selected (block 501 in FIG. 5) from the languages available for the device in which the speech recognition will be implemented. Then, if the vocabulary of the selected language which will be used in the device can not be processed in one block, the vocabulary will be processed in more than one block. Therefore, one block of words of the vocabulary is selected 502 for the processing. Then, the words of the block are examined 503 to identify, when necessary, which of the words of the block belong to the selected language so that phonemes are generated to only real words of the language.

After the real words of the language are identified, the subword of the language is selected 504 for the processing. The subword may be any subword unit of the language. The order in which the subwords are selected is normally not meaningful for the implementation of the present invention. For the selected subword, the decision tree of the selected subword is loaded into the RAM memory, thereafter the words of the current block are examined to find out which of the words of the current block contain that subword (if any). The examination can be performed, for example, in such a way that the first word of the current block of words loaded into the RAM memory 305 is examined first (block 506 of the flow diagram in FIG. 5). If the word contains that subword, phonemes are generated 507 for that subword of the word. If the word contains more than one of this subword the phonemes are generated for all the occurrences of that subword in the word under examination. The phonemes are stored, for example, into the RAM memory. In the next step 508 it is examined if there are any unexamined words in the current block of words. If not all the words of the current block are not examined another word of the current block is selected 509 for examination and it is examined if the word contains the current subword i.e. the steps 506, 507 and 508 are repeated. When the occurrences of the current subword in the words of the current block are examined, the process continues in step 510 in which it is examined if there exists any unexamined subwords for the current language. If not all the subwords are examined, another subword of the current language is selected 511 for the examination and the decision tree of that subword is loaded into the RAM memory 305 (step 504). The decision tree of the previous subword is not needed wherein the decision tree of the previous subword can be overloaded with the decision tree of the subword selected at step 511.

When all the subwords are examined all the phoneme transcriptions of the subwords of individual words are concatenated 512. In other words, the phoneme transcriptions of the subwords of the first word of the block of words are concatenated as the phoneme transcription of that word, the phoneme transcriptions of the subwords of the second word are concatenated as the phoneme transcriptions of the second word etc.

At step 513 an examination is performed, when necessary, to find out if there are any unexamined block of words left. If so, another block of words is loaded to the RAM memory 305 and the occurrences of different subwords in the words are examined as described above (the steps 503 through 512).

After all the blocks of words are processed it is examined (block 515), when necessary, if all the supported languages are processed or not. If there are one or more unprocessed languages left, another language is selected 516 and the above described process will be repeated for the selected language(s) i.e. the steps 502 through 516.

Although it was mentioned above that the phoneme generation process is performed for all the subwords of the language, the invention can also be implemented so that it is examines which subwords exist in the words and after that the process is not performed to those subwords not existing in the words. This kind of arrangement can reduce the amount of data to be loaded to the RAM memory and the processing time because the loading of the decision trees for the subwords, which do not exist in the vocabulary, is not needed.

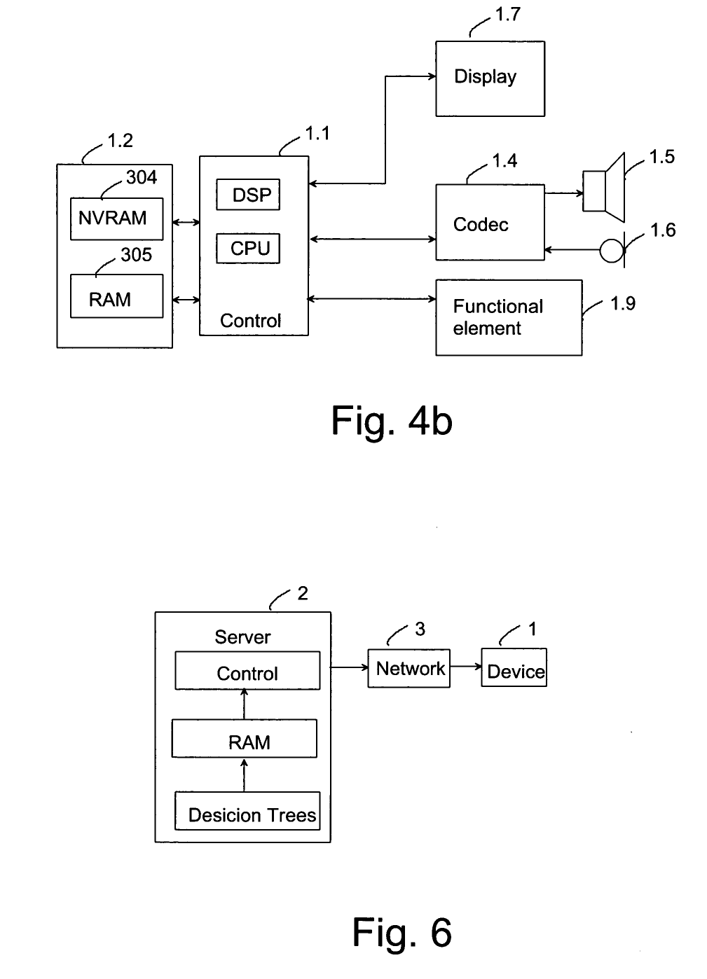

The phoneme transcriptions generated for the vocabularies of different languages can be used by the speech recognizer of a device. The speech recognizer is using, for example, the Hidden Markov Model (HMM). FIG. 4a depicts an example embodiment of a device 1 in which the invention can be applied. The device 1 comprises a control element 1.1 which may comprise a microprocessor CPU, a digital signal processor DSP and/or another processing unit. The device 1 also has memory 1.2 which may contain a mass memory 304 such as a non-volatile memory, a RAM memory 305 etc. The device 1 of FIG. 4a also comprises a keyboard 1.3, audio means, such as a codec 1.4, a loudspeaker 1.5 and a microphone 1.6, a display 1.7, and a transceiver 1.8 or other communication means. The mass memory 304 of the device 1 may contain the vocabulary, the decision trees and other necessary information for performing the steps of the phoneme generation process according to the present invention. It is also possible that the decision trees are loaded from a server 2 (FIG. 6) (via a network 3 or directly) by the transceiver 1.8 when the vocabulary is processed for the phoneme generation. As was disclosed previously in this description, the phoneme generation may be performed outside the device 1, for example in the server 2. In this case the device 1 may not need the decision tree information at all and the generated phoneme transcriptions are loaded from e.g. the server 2 to the device 1 in which the phoneme transcriptions are stored. The server 2 can also be a personal computer such as a laptop wherein a short range communication may be utilized when transferring information between the server 2 and the device 1.

In FIG. 4b another device 1 in which the invention can be implemented is depicted. The device of FIG. 4b does not have the transceiver 1.8 but the device 1 comprises a functional element 1.9 which can be any kind of unit or group of units for which the control element 1.1 of the device 1 can produce control information and/or from which the control element 1.1 can receive status information etc. The functional element 1.9 can comprise, for example, one or more motors, valves, solenoids, sensors, etc.

The device 1 can be any electronic device, electric device etc. in which speech recognizing will be performed, for example, to control the device 1. Some non-limiting examples of such devices 1 are wireless communication devices, personal digital assistance devices (PDAs), headsets, cars, hands free equipment, washing machines, dish machines, locks, intelligent buildings etc.

The method of the present invention can be implemented at least partly as a computer program, for example as a program code of the digital signal processor and/or the microprocessor. The speech recognizer can also be implemented as a computer program in the control element.

The invention can also be implemented as a module which comprises some or all of the elements of the phoneme generating unit 300 of FIG. 3. The module can then be arranged in connection with another device 1 in which the text-to-phoneme mapping process will be utilized.

In another example embodiment of the present invention it is also possible that for example the user of the device 1 can update the vocabulary at a later stage. The user can input new word(s) e.g. by the keyboard 1.3 wherein the subwords of the inputted word(s) are examined and the phoneme transcriptions generated for the inputted word(s) by using the method according to the invention.

It is also possible that the vocabulary is defined by an application which is run in the device 1 or by a content which is utilized by the application. For example, the application may comprise a set of command words wherein the phoneme transcriptions are generated for those command words when the application is started in the device. It may also be possible that if the set. of command words is fixed for the application, the phoneme transcriptions are generated when the application is installed on the device 1. If the vocabulary is variable, for example when the user uses a browser application to browse pages on the internet the pages may contain words for which the phoneme transcriptions can be generated. This can be performed e.g. so that the page contains an indication on such words and the browser application recognizes such words. The browser application may then inform, for example, the operating system of the device 1 to start an application which performs the phoneme generation process according to the present invention.

In addition to the non-limiting examples mentioned above there can also be many other situations triggering the phoneme generation process.

As was illustrated above, the decision tree based text-to-phoneme process is implemented in the present invention so that there is an individual decision tree model for each subword. In addition, due to the definition of the decision tree data structure, it is possible to access the data of the individual decision trees in a random order. Therefore, it is possible to do the decoding subword by subword. The pseudocode for the decision tree based text-to-phoneme decoding according to the invention can therefore be presented as follows.

for ALL LANGUAGES

Check if language present in entries

if LANGUAGE PRESENT

Initialize text-to-phoneme for the language, general data
Construct the alphabet of subwords for the language
for ALL SUBWORDS IN LANGUAGE

Check if subword present in the entries
if SUBWORD PRESENT

Initialize the decision tree for the subword
for ALL ENTRIES

Do symbol conversions for the entry
Produce text-to-phoneme for the subword

end for
Clear the decision tree for the subword

end if

end for
Clear text-to-phoneme, general part

end if

end for

In this implementation, there is no overhead of transferring the data from the mass storage 304 (e.g. flash) into RAM memory 305 since each tree can be arranged to be loaded only once. In fact, the total amount of data that is loaded can be even smaller if there is a subword in the alphabet that is not present in the entries because that subword need not be processed.

The data of the decision tree based text-to-phoneme model is prepared in such a way that the subword by subword decoding is possible. The data of the prior art decision tree based text-to-phoneme model contain:
Subword, phoneme, and phoneme class definitions
Number of decision trees
The data of the decision trees

The subword, phoneme and phoneme class definitions are language dependent and they are shared among the individual tree models. The individual decision trees model the pronunciations of each subword in the alphabet. In order to do the decision tree based text-to-phoneme decoding according to the present invention, i.e. subword by subword, the data of the decision trees is stored, for example, in such a way that all the data of a single decision tree is kept in a continuous memory range. In addition, the text-to-phoneme data of the individual decision tree models are arranged to be accessible in a random order. Therefore, the start addresses of the individual decision trees are stored in the decision tree database in the mass memory 304. Due to these requirements, the data of the decision tree based text-to-phoneme model according to an example embodiment of the present invention contains:
Subword and phoneme definitions;
Number of single decision trees for random access;
The start addresses or other appropriate information of the beginning of single decision trees;
Number of decision trees;
The data of the individual decision trees, the data of a single subword in a continuous memory range.

During the execution of the phoneme generation process, the instances of the decision tree based text-to-phoneme model structures are created. In the example implementation of the present invention, the text-to-phoneme model data structure is defined as follows.

typedef struct {

TreeInfo_t TreeInfo;
DecTreeAccess_t DecTreeAccess;
StorageSpace_t aDataArea;
DecTree_t *DecTree;
uint8 NumTrees;
uint16 *nameInd;
uint16 *phoneSeq;

} ttpDTData_t;

The first member TreeInfo of the data structure stores the alphabet of subwords and the phoneme definitions for the decision tree based text-to-phoneme model of a single language. The second member DecTreeAccess of the data structure is a structure that stores the information needed to access the individual trees in a random manner. The third member aDataArea of the data structure stores the start address of the whole decision tree based text-to-phoneme model for the current language. The fourth member *DecTree of the data contains the individual decision tree for the current subword of the language. The fifth member NumTrees stores the number of individual decision trees for the language. The sixth nameInd and seventh members phoneSeq of the data structure are temporary variables that are allocated and cleared during the text-to-phoneme processing.

In the example implementation of the invention the second and third members of the data structure are the most important ones. The second member DecTreeAccess of the data structure can be defined as follows.

typedef struct {

uint32 BytesTree;
uint32 *IndData;
uint8 NumTrees;

} DecTreeAccess_t;

The members of this structure are the total size of the decision trees (BytesTree), the start addresses of the single decision trees (*IndData), the number of individual decision trees (NumTrees). At least the start addresses of the individual decision trees are stored into the database on the mass memory 304.

As was described above the phoneme context is not used in the present invention. In order to check the feasibility of the approach, the text-to-phoneme and recognition experiments were carried out.

In the experiments, the text-to-phoneme models were trained with and without the phoneme context. The experiments with the phoneme context set the baseline against which the performance is evaluated. The experiments were carried out for the following languages: Danish, Dutch, French, German, Latvian, Portuguese, Slovenian, Spanish, and British English. First, the performance of the decision tree based text-to-phoneme mapping was evaluated by training the mappings with and without the phoneme context and computing the phoneme accuracies on the training data. In addition, the sizes of the decision tree based text-to-phoneme models stored on the disk are listed for both configurations. Table 1 presents the phoneme accuracies and Table 2 the memory requirements for both configurations. (NOTE: Commas represent American decimal points in tables that follow.)

TABLE 1
Phoneme accuracies for both the text-to-phoneme models with
the phoneme context (prior art) and without the phoneme context
(the invention). The phoneme accuracies are in %.

| Language | Full context | Low RAM |
|---|---|---|
| dan | 99.78 | 99.61 |
| dut | 99.74 | 99.72 |
| fre | 99.91 | 99.88 |
| ger | 99.95 | 99.94 |
| lat | 99.98 | 99.98 |
| por | 99.88 | 99.87 |
| slo | 99.97 | 99.96 |
| spa | 100.00 | 100.00 |
| uk | 98.97 | 98.87 |

TABLE 2
Memory requirements for both the text-to-phoneme models with
the phoneme context (prior art) and without (the invention).
The memory figures are the sizes of the decision tree based
text-to-phoneme models on the disk measured in kilobytes.

| Language | Full context | Low RAM |
|---|---|---|
| dan | 120.46 | 143.47 |
| dut | 23.01 | 23.96 |
| fre | 24.84 | 27.93 |
| ger | 74.28 | 77.47 |
| lat | 12.52 | 12.86 |
| por | 8.54 | 8.81 |
| slo | 36.32 | 35.65 |
| spa | 8.17 | 8.60 |
| uk | 168.63 | 167.54 |

It should be noted here that in the implementations of the present invention the mass memory requirements (for example flash memory) may be slightly increased compared to prior art but the RAM memory requirements are smaller than RAM memory requirements in prior art.

As can be seen from Table 1, for the languages in the tests, the phoneme accuracy does not degrade much with the implementation of the decision tree based text-to-phoneme mapping according to the present invention. Table 2 suggests that the implementation according to the present invention does not increase the memory requirements much (except for Danish).

In addition to the tests with the text-to-phoneme mapping, the recognition experiments were carried out in clean and in noise to see the effect of the change in the text-to-phoneme model on the recognition accuracy. The recognition experiments were carried out on a test database. The results of the recognition experiments are presented in Table 3 for the clean conditions and in Table 4 for the noisy conditions. The noisy waveforms were obtained from the clean ones by adding pre-recorded noise. The signal to noise ratio was between +20 and +5 dB in the noisy experiments.

TABLE 3
Recognition results on a test database, clean waveforms.
The recognition rates are in %.

| Language | Full context | Low RAM |
|---|---|---|
| Dan | 95.00 | 95.26 |
| Dut | 97.17 | 97.52 |
| Fre | 95.69 | 95.55 |
| Ger | 97.58 | 98.18 |
| Lat | 98.52 | 98.52 |
| Por | 92.18 | 92.84 |
| Slo | 98.42 | 98.42 |
| Spa | 98.96 | 98.96 |
| Uk | 92.09 | 92.32 |

TABLE 4
Recognition results on a test database, noisy waveforms, signal
to noise ratio [+5, +20] dB. The recognition rates are in %.

| Language | Full context | Low RAM |
|---|---|---|
| dan | 86.96 | 87.21 |
| dut | 92.07 | 92.35 |
| fre | 89.08 | 89.08 |
| ger | 88.19 | 88.37 |
| lat | 95.32 | 95.32 |
| por | 81.91 | 81.87 |
| slo | 90.78 | 90.83 |
| spa | 91.73 | 91.73 |
| uk | 77.25 | 77.13 |

As can be seen from the recognition rates, the results with the implementation according to the present invention show minor improvements for some languages, minor degradation for some languages, and the results do not change for some languages. Therefore it can be concluded that there is no major degradation in the recognition performance due to the implementation according to the present invention.

As a conclusion from the text-to-phoneme tests and the recognition experiments, the implementation according to the present invention seems to be feasible without degradations in the accuracy of the mapping. In addition, the memory requirements are not increased much due to the implementation according to the present invention. Usually, the increase in the memory requirements is in the order of kilobytes. There is even a slight reduction in the memory requirements for some languages.

The benefit of the implementation according to the present invention can be seen in Table 5 which presents the RAM memory footprint for one prior art implementation and an example implementation of the present invention (called as Low RAM in the Table). All the memory figures are in kilobytes. The RAM footprints are computed after the initialisation of the actual decision tree based text-to-phoneme data structures. In the Table, also the overhead of storing the intermediate pronunciations for the subwords in the entries is presented. From the table it can be seen that for all the languages the footprint of RAM can be made smaller. The overhead of bookkeeping for storing the intermediate pronunciations can be made smaller by further optimisation of the implementation. Clearly, for languages with large decision trees, the approach reduces the RAM footprint.

TABLE 5

| Language | Baseline | Low RAM | Overhead |
|---|---|---|---|
| dan | 127.50 | 43.87 | 6.63 |
| dut | 26.71 | 6.37 | 7.17 |
| fre | 26.52 | 5.87 | 7.14 |
| ger | 77.32 | 18.71 | 6.72 |
| lat | 13.85 | 3.13 | 7.20 |
| por | 11.01 | 2.56 | 7.07 |
| slo | 36.29 | 13.26 | 7.02 |
| spa | 8.02 | 1.13 | 6.70 |
| uk | 171.49 | 37.92 | 6.35 |

It is also possible that some parts of the invention are implemented outside of the device in which the speech recognition is used. For example, the device may transmit speech or speech features to a server which forms the transcriptions, performs speech recognition and sends the results to the device.

It is obvious that the embodiments described above should not be interpreted as limitations of the invention but they can vary in the scope of the inventive features presented in the following claims.

1. A speech recognizer comprising:
a random access memory;
a downloader for loading decision trees from a set of decision trees into said random access memory;
a vocabulary comprising one or more words of a language;
a divider for dividing at least one word of said vocabulary into subwords;
a transcription generator adapted to process at least one subword, wherein the downloader is adapted to download a subset of the set of decision trees at a time into said random access memory, and the transcription generator is further adapted to generate at least one phoneme transcription for said subword using said subset of the decision trees; and
a combiner for combining generated phoneme transcriptions of the subwords to obtain phoneme transcriptions of said one or more words.

2. A device according to claim 1 comprising said transcription generator adapted to generate at least one phoneme transcription for the current subword for those words which contain the current subword.

3. A device according to claim 1 comprising said transcription generator adapted to process the words of the vocabulary subword-by-subword.

4. A device according to claim 1 comprising said transcription generator adapted to examine which words of the vocabulary contain a current subword.

5. A device according to claim 1 comprising said divider adapted to divide said at least one word into subwords.

6. A device according to claim 5 comprising said transcription generator adapted to process the words of the vocabulary subword-by-subword.

7. A device comprising:
a random access memory;
a downloader for loading decision trees from a set of decision trees into said random access memory;
a vocabulary comprising one or more words of a language;
a divider for dividing at least one word of said vocabulary into subwords;
a transcription generator adapted to process at least one subword, wherein the downloader is adapted to download a subset of the set of decision trees at a time into said random access memory, and the transcription generator is further adapted to generate at least one phoneme transcription for said subword using said subset of the decision trees; and
a combiner for combining the generated phoneme transcriptions of the subwords to obtain phoneme transcriptions of said one or more words.

8. A device according to claim 7 comprising said transcription generator adapted to generate at least one phoneme transcription for the current subword for those words which contain the current subword.

9. A device according to claim 7 comprising said transcription generator adapted to process the words of the vocabulary subword-by-subword.

10. A device according to claim 7 comprising said transcription generator adapted to examine which words of the vocabulary contain a current subword.

11. A device according to claim 7 comprising said divider adapted to divide said at least one word intosubwords.

12. A device according to claim 7 comprising a mass memory for storing the decision trees, wherein said downloader is adapted to download the decision trees from said mass memory to said random access memory.

13. A device according to claim 7 comprising a language identifier for identifying a language of a word.

14. A device according to claim 7 comprising a storage for storing the phoneme transcriptions of the words.

15. A device according to claim 9 wherein said combiner is adapted to perform the combining after the transcription generator has performed the subword-by-subword processing of the words of the vocabulary of the language.

16. A device according to claim 15 wherein said combiner is adapted to perform the combining after the transcription generator has performed the subword-by-subword processing of a subset.

17. A device according to claim 7 wherein said transcription generator is adapted to process the words of the vocabulary in at least two subset of words of the vocabulary.

18. A device according to claim 7 comprising a word handler for examining which subwords of the current language exist in the words, wherein transcription generator is adapted to process only those subwords of the current language which exist in at least one of the words.

19. A device according to claim 7 comprising a processor for executing a program which produces information containing one or more words, therein the transcription generator is adapted to produce phoneme information for at least one of the words produced by the program.

20. A wireless communication device comprising:
a random access memory;
a downloader for loading decision trees from a set of decision trees into said random access memory;
a vocabulary comprising one or more words of a language;
a divider for dividing at least one word of said vocabulary into subwords;
a transcription generator adapted to process at least one subword, wherein the downloader is adapted to download a subset of the set of decision trees at a time into said random access memory, and the transcription generator is further adapted to generate at least one phoneme transcription for said subword using said subset of the decision trees; and
a combiner for combining the generated phoneme transcriptions of the subwords to obtain phoneme transcriptions of said one or more words.

21. A system comprising
a server comprising a mass memory for storing a set of decision trees, and a transmitter for transmitting information from the server;
a device comprising
a receiver for receiving information from the server;
a random access memory;
a downloader for loading decision trees from the set of decision trees from said server into said random access memory;
a vocabulary comprising one or more words of a language;
a divider for dividing at least one word of said vocabulary into subwords;
a transcription generator adapted to process at least one subword, wherein the downloader is adapted to download a subset of the set of decision trees at a time into said random access memory, and the transcription generator is further adapted to generate at least one phoneme transcription for said subword using said subset of the decision trees; and
a combiner for combining the generated phoneme transcriptions of the subwords to obtain phoneme transcriptions of said one or more words.

22. A module comprising:
a downloader for loading decision trees from a set of decision trees into a random access memory;
a divider for dividing at least one word of said vocabulary into subwords;
a transcription generator adapted to process at least one subword of a vocabulary, said vocabulary comprising one or more words of a language, wherein the downloader is adapted to download a subset of the set of decision trees at a time into said random access memory, and the transcription generator is further adapted to generate at least one phoneme transcription for said subword using said subset of the decision trees; and
a combiner for combining the generated phoneme transcriptions of the subwords to obtain phoneme transcriptions of said one or more words.

23. A method for generating the phoneme transcriptions of words of a vocabulary of a language comprising:
loading decision trees into a random access memory;
processing at least one subword of a vocabulary, wherein the processing comprising downloading a subset of the set of decision trees at a time into said random access memory, and generating at least one phoneme transcription for said subword using said subset of the decision trees; and
combining the generated phoneme transcriptions of the subwords to obtain phoneme transcriptions of said one or more words.

24. A computer program product for generating the phoneme transcriptions of words of a vocabulary of a language when executed on a processor, the computer program product comprising machine executable steps stored in an addressable memory, the machine executable steps for:
loading decision trees into a random access memory;
processing the words of the vocabulary subword-by-subword, wherein the processing comprising downloading a subset of the set of decision trees at a time into said random access memory, and generating at least one phoneme transciption for said subword using said subset of the decision trees; and
combining the generated phoneme transcriptions of the subwords to obtain phoneme transcriptions of said one or more words.

25. A data structure including words of at least one vocabulary of at least one language for processing subwords of the words of the vocabulary, the data structure comprising:
subword and phoneme definitions;
decision trees for single subwords arranged for random access of the decision trees;
the data of the decision trees comprising information for obtaining phoneme transcriptions from subwords.

26. A data structure according to claim 25 also comprising: phoneme class definitions;
information on the beginning of single decision trees; and
number of decision trees.

27. A method for producing a data structure including words of at least one vocabulary of at least one language for processing subwords of the words of the vocabulary, the method comprising
obtaining subword and phoneme definitions;
forming decision trees for single subwords on the basis of the phoneme definitions; and
arranging said decision trees for single subwords for random access.

28. A computer program product for producing a data structure including words of at least one vocabulary of at least one language for processing subwords of the words of the vocabulary when executed on a processor, the computer program product, the computer program product comprising machine executable steps stored in an addressable memory, the machine executable steps for:
obtaining subword and phoneme definitions;
forming decision trees for single subwords on the basis of the phoneme definitions; and
arranging said decision trees for single subwords for random access.
